(19) United States
(12) Patent Application Publication
(10) Pub. No.: US 2004/0199735 A1
(43) Pub. Date: Oct. 7, 2004

(54) Write-protect method for storage device

(76) Inventor: Wu-Sung Lee, Taoyuan City (TW)

Correspondence Address: SNELL & WILMER, ONE ARIZONA CENTER, 400 EAST VAN BUREN, PHOENIX, AZ, 850040001

(21) Appl. No.: 10/803,836

(22) Filed: Mar. 18, 2004

(30) Foreign Application Priority Data
Apr. 7, 2003 (TW) 92107922

(51) Int. Cl. G06F 12/14

(52) U.S. Cl. 711/163; 711/103

(57) ABSTRACT

A method for write-disabling a storage device is provided. The storage device includes a storage medium and a firmware. The method includes: (a) storing a first parameter in the storage medium; (b) receiving the first parameter from the storage medium by the firmware when the firmware receives a write command, and (c) refusing to execute the write command when the first parameter equals a predetermined disable parameter.

### CROSS-REFERENCE TO RELATED APPLICATION

This application claims priority of Taiwan Patent Application Serial No. 092107922 filed on Apr. 07, 2003.

### FIELD OF INVENTION

The present invention relates to a method for write-disabling a storage device.

### BACKGROUND OF THE INVENTION

As the capacity of storage devices increases and their read/write time decreases, it is becoming more and more convenient to copy a large volume of data in a very short time from a computer with one of these storage devices, such as CD-R devices, CD-RW devices, DVD write/read devices, portable hard disks and flash disks. Therefore, it is important to protect confidential information from unauthorized copying via the storage devices.

Generally, password-protecting mechanisms for the computer are widely used to prevent unauthorized copying. However, the password-protecting mechanisms disable not only the write function of the storage device but also other functions of the computer. It is inconvenient for users to utilize other functions, such as reading files, of the computer.

To solve this problem, a method for write-disabling a storage device is presented to disable only the write function of the storage device while leaving the other functions of the computer activated.

### SUMMARY OF THE INVENTION

The main aspect of the present invention provides a method for write-disabling a storage device to disable the write function of the storage device.

Another aspect of the present invention provides a method for write-disabling a storage device to allow authorized users to disable the write function of the storage device.

The storage device mentioned above, connected to a processing device, includes a storage medium and a firmware. The method for write-disabling a storage device includes:

(a) storing a first parameter in the storage medium; (b) receiving the first parameter from the storage medium by the firmware when said firmware receives a write command from the processing device; and (c) refusing to execute the write command by the firmware when the first parameter equals to a predetermined disable parameter.

### BRIEF DESCRIPTION OF THE DRAWINGS

For a more comprehensive understanding of the present invention, reference is now made to the following descriptions taken in conjunction with the accompanying drawings.

FIG. 1a is a system block diagram according to an embodiment of the present invention;

FIG. 1b is a system block diagram according to another embodiment of the present invention;

FIG. 2 is a flow chart according to an embodiment of the present invention;

FIG. 3 is a system block diagram according to still another embodiment of the present invention; and

FIG. 4 is a flow chart of storing a first parameter in the first memory according to an embodiment of the present invention.

### DETAILED DESCRIPTION

A method for write-disabling a storage device is presented. In an exemplary embodiment, the storage device 200 is a disc read/write device, such as a CD-R device, a CD-RW device or a DVD write/read device. In other embodiments, the storage device 200 could be an MO drive, a floppy disk drive, a hard disk drive, a portable disk drive, a flash disk drive or a memory card.

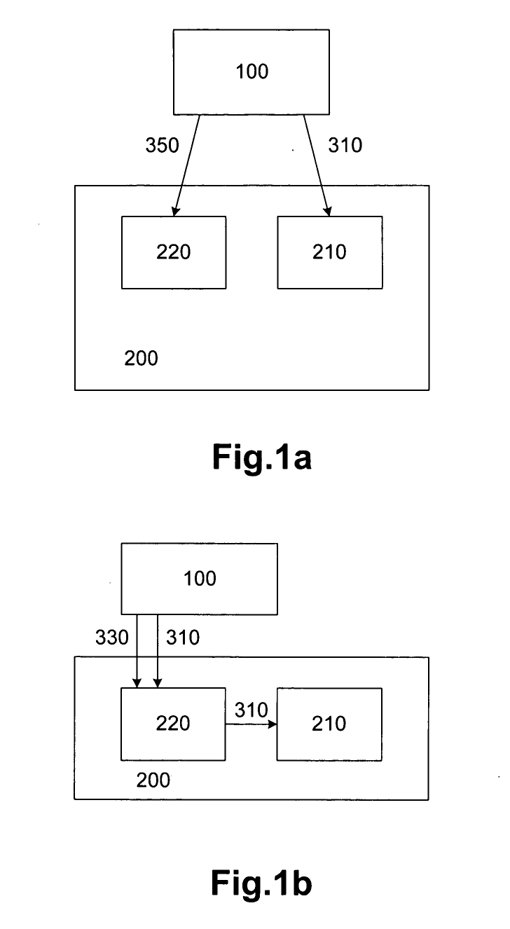

FIG. 1a shows a block diagram of a first embodiment. In FIG. 1a, the storage device 200 includes a storage medium 210 and a firmware 220. The storage device 200 is connected to a processing device 100. The processing device 100 is used for reading data from and writing data in the storage medium 210. In the exemplary embodiment, the processing device 100 is a personal computer. In other embodiments, the processing device 100 can be a laptop computer, a tablet computer, a PDA, a CPU or any other devices with similar functions.

FIG. 1b shows a block diagram of a second embodiment. As opposed to the diagram in FIG. 1a, the processing device 100 in FIG. 1b is connected to the storage medium 210 via the firmware 220. It should be noted that embodiments illustrated in FIG. 1a and FIG. 1b do not limit the scope of the present invention, which can be used in conjunction with other similar systems.

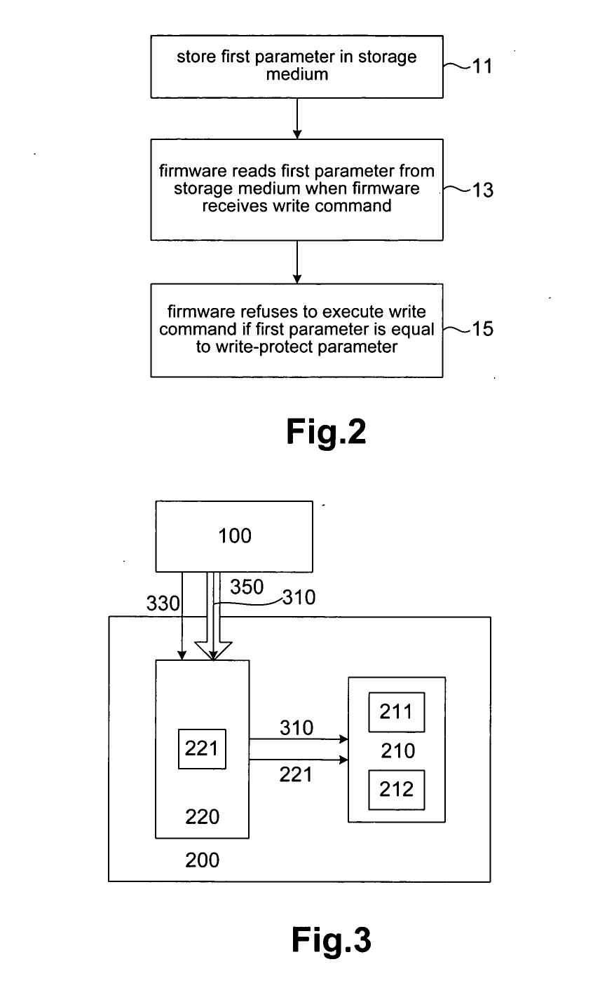

FIG. 2 illustrates a flow chart of the present invention. The first step 11 is to store the first parameter 310 in the storage medium 210. In the first embodiment, the first step 11 is construed such that the processing device 100 transmits the first parameter 310 to the storage medium 210. In the second embodiment, in accordance with the system illustrated in FIG. 1b, the processing device 100 transmits the first parameter 310 to the firmware 220, and then the firmware 220 stores the first parameter 310 in the storage medium 210. That is, the processing device 100 includes certain application programs for transmitting the first parameter 310. These application programs comply with Advanced Technology Attachment Programming Interface (ATAPI) or other similar protocols. The processing device 100 also includes an operation interface for users to configure and use the application programs mentioned above. Furthermore, users can protect the operation interface and the application programs by a password.

In the embodiment discussed here, the first parameter 310, separated from the other data, is stored in a specific location of the storage medium 210. However, in other embodiments, the first parameter 310 can be stored in a random location of the storage medium 210.

In the second step 13, the firmware 220 reads the first parameter 310 from the storage medium 210 when the firmware 220 receives a write command 330 from the processing device 100. In these embodiments, when a user executes a writing function of a writing program, the processing device 100 transmits a write command 330 to the firmware 220. Because the first parameter 310 is stored in a specific location of the storage medium 210, the firmware 220 routinely retrieves the first parameter 310 from the aforementioned specific location.

In the final step 15, when the first parameter 310 equals a predetermined disable parameter, the firmware 220 will refuse to execute the write command 330. The predetermined disable parameter is stored in the firmware 220 in advanced for the embodiment discussed here. In other embodiments, the predetermined disable parameter is transmitted to the firmware 220 by the processing device 100 or is read from the storage device 210 by the firmware 220. The predetermined disable parameter in the embodiment is a specific code for disabling a write function; in other embodiments, the predetermined disable parameter can be other code or value, such as an arbitrary natural number.

FIG. 3 shows a block diagram of a third embodiment. The storage medium 210 further includes a first memory 211 and a second memory 212. In the first step 11, the second memory 212 can be used to store the first parameter 310 in the first memory 211. In this embodiment, the first memory 211 is a flash memory and the second memory 212 is an SRAM. In other embodiments, the first memory 211 can be a DRAM, an SRAM or any other type of memory, and the second memory 212 can be a DRAM, a flash memory or any other type of memory.

As shown in FIG. 3, the processing device 100 transmits a message 350 including the first parameter 310 to the firmware 220. In this embodiment, the message 350 complies with ATAPI or other similar protocols. The firmware 220 further includes an updating program 221 for storing the first parameter 310 in the first memory 211.

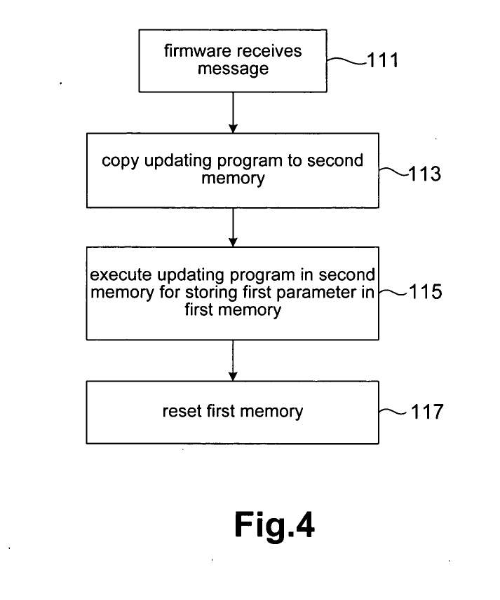

With the system illustrated in FIG. 3, in the first step 11, the first parameter 310 can be recorded in the first memory 211 of the storage medium 210 by utilizing a method described in FIG. 4. As shown in FIG. 4, the firmware 220 first receives the message 350 in step 111. In this embodiment, the firmware 220 receives the message 350 with the first parameter 310 from the processing device 100.

The firmware 220 further includes an updating program 221. In step 113, the firmware 221 copies the updating program 221 to the second memory 212. In other embodiments, the copying step can be executed by the processing device 100 or other similar devices.

In the following step 115, the updating program 221 in the second memory 212 is executed to store the first parameter 310 in the first memory 211. In this embodiment, step 115 is construed such that the firmware 220 executes the updating program 221 in the second memory 212. In other embodiments, the updating program 221 could be auto-executed in the second memory 212.

The final step is to reset the first memory 211, as shown in step 117. In this embodiment, step 117 is construed such that the firmware 220 resets the first memory 211. In other embodiments, it can be the processing device 100 or other similar devices that reset the first memory 211. It should be noted that the method illustrated in FIG. 4 could be performed by similar systems other than the one shown in FIG. 3.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A method for write-disabling a storage device, said storage device having a storage medium and a firmware, said storage device connected to a processing device writing and reading data from said storage medium, said method comprising steps of:
(a) storing a first parameter in said storage medium;
(b) receiving said first parameter from said storage medium by said firmware when said firmware receives a write command from said processing device; and
(c) refusing to execute said write command by said firmware when said first parameter equals a predetermined disable parameter.

2. The method of claim 1, wherein said storage medium further comprises a first memory and a second memory, and said first parameter is stored in said first memory.

3. The method of claim 2, wherein said first memory is a flash memory, and said second memory is an SRAM.

4. The method of claim 2, wherein said first parameter is included in a message encoded in accordance with Advanced Technology Attachment Programming Interface (ATAPI).

5. The method of claim 4, wherein said first parameter is stored in said first memory via said second memory.

6. The method of claim 4, wherein said firmware comprises an updating program, said step (a) comprises steps for storing a first parameter in said first memory, and said steps comprise:
(d) receiving said message by said firmware;
(e) copying said updating program to said second memory;
(f) executing said updating program in said second memory for storing said first parameter in said first memory; and
(g) resetting in said first memory.

7. The method of claim 1, wherein said predetermined disable parameter complies with ATAPI.

8. The method of claim 7, wherein said predetermined disable parameter is defined by a code for disabling a write function.

9. The method of claim 1, wherein said processing device is a personal computer.

10. The method of claim 1, wherein said storage device is a disc read/write device.

11. The method of claim 10, wherein said disc read/write device is a CD-RW.

12. The method of claim 10, wherein said disc read/write device is a DVD-RW.
